(19) United States
(12) Patent Application Publication
(10) Pub. No.: US 2025/0161825 A1
(43) Pub. Date: May 22, 2025

(54) FANTASY SPORTS PLATFORM WITH REAL-TIME INTERACTIVITY

(71) Applicants: Stephen Beuerlein, Irvine, CA (US); Steve T. Mandell, Chicago, IL (US)

(72) Inventors: Stephen Beuerlein, Irvine, CA (US); Steve T. Mandell, Chicago, IL (US)

(21) Appl. No.: 18/957,337

(22) Filed: Nov. 22, 2024

Related U.S. Application Data
(60) Provisional application No. 63/601,970, filed on Nov. 22, 2023.

(51) Int. Cl. A63F 13/828

(52) U.S. Cl. CPC A63F 13/828

(57) ABSTRACT

The fantasy sports platform allows fantasy players to form and manage fantasy leagues. In particular, the fantasy sports platform allows real-time player swaps during fantasy league matches between fantasy players at any clock stoppages or player substitutions. The clock stoppages or player substitutions are acquired from real-time data feeds and synchronized to ensure the player swaps are available and permitted by fantasy league rules. The fantasy sports platform also provides other information to players such as schedules, upcoming league, roster management, and league management.

### FIELD OF THE INVENTION

This application claims priority to U.S. Provisional Application Ser. No. 63/601,970, filed Nov. 22, 2023, the entire contents of which are hereby incorporated by reference in their entirety.

### FIELD OF THE INVENTION

The present invention relates a fantasy sports platform incorporating real-time player swaps. More specifically, the present invention relates to a fantasy sports platform allowing player or other swaps at any reported clock stoppages or official player substitutions.

### BACKGROUND

The fantasy sports market is one of the numerous multi-billion-dollar industries that offers various kinds of interactive virtual games to players. Fantasy sports players are younger, better educated, with higher household incomes and more likely to have fulltime employment. Fantasy sports leagues currently exist for almost organized sports such as football, baseball, basketball etc. It is estimated that more than sixty (60) million players participate in fantasy sports in the US and over 100 million players participate in fantasy sports in India, and the market is still growing.

Taking fantasy football as an example, the typical user spends an average of three (3) hours each week managing a team and over several hours a week watching games during the season. In the United States alone, at twenty-nine (29) million users over an eighteen (18) week season, that is over one (1) billion hours spent by dedicated fans. The time, energy and research into a fantasy team is extensive. However, unlike coaches or managers, fantasy sports users currently have no ability to replace, in real-time, in the middle of a game, a sub-performing player, or even worse, an injured player that cannot return to the game. This can result in a loss for a user due to injury (or even game cancellation) because there is no ability to replace the injured or sub-performing player.

Therefore, a need exists for a fantasy sports platform in which different selections, such as teams or players, can be swapped in real-time by each individual player in the fantasy sports league. This would increase engagement with the fantasy sports platform because swaps can be made at any time, leading players to engage with the fantasy sports platform not only during selection of a roster, but also during games or matches.

### SUMMARY

The present invention describes a fantasy sports platform that allows fantasy players to form, engage with, and manage fantasy leagues. In particular, the fantasy sports platform allows real-time player swaps during fantasy league matches at any clock stoppage. The clock stoppages are acquired from real-time data feeds and synchronized to ensure the player swaps are available and permitted by fantasy league rules. The fantasy sports platform also provides other information to players such as schedules, upcoming league, roster management, and league management.

### BRIEF DESCRIPTION OF THE DRAWINGS

FIG. 1 depicts a system diagram of the fantasy sports platform according to an embodiment of the present invention.

FIGS. 2-4 depict sample screens that a fantasy user can utilize to join an open league.

FIGS. 5-10 depict the steps utilized to create a new fantasy league according to an embodiment of the invention.

FIGS. 11-14 depict an example home screen for the mobile application according to an embodiment of the invention.

FIGS. 15-24 depict screens showing various features associated with the roster option from the home screen.

FIG. 25A-25B depict screens showing a sample user interface for an in-progress match for a user.

FIGS. 26A-26C depict lineup players and bench players that are available for real-time swaps using the fantasy sports platform.

FIGS. 27A-27B depict example screens showing the acceptance or rejection of a swap, respectively.

FIGS. 28-29 depict example screens showing how fantasy points are accrued for fantasy user in a match.

FIGS. 30-32 depict an example commissioner interface used for setting and monitoring fantasy league settings.

FIG. 33 depicts a flowchart showing the system components of the fantasy sports platform used to process player swaps.

FIG. 34 depicts a flowchart showing how points are accumulated by users in response to different types of player swaps.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below is intended as a description of various implementations and is not intended to represent the only implementations in which the subject technology may be practiced. As those skilled in the art would realize, the described implementations may be modified in various different ways, all without departing from the scope of the present disclosure. Accordingly, the drawings and description are to be regarded as illustrative in nature and not restrictive.

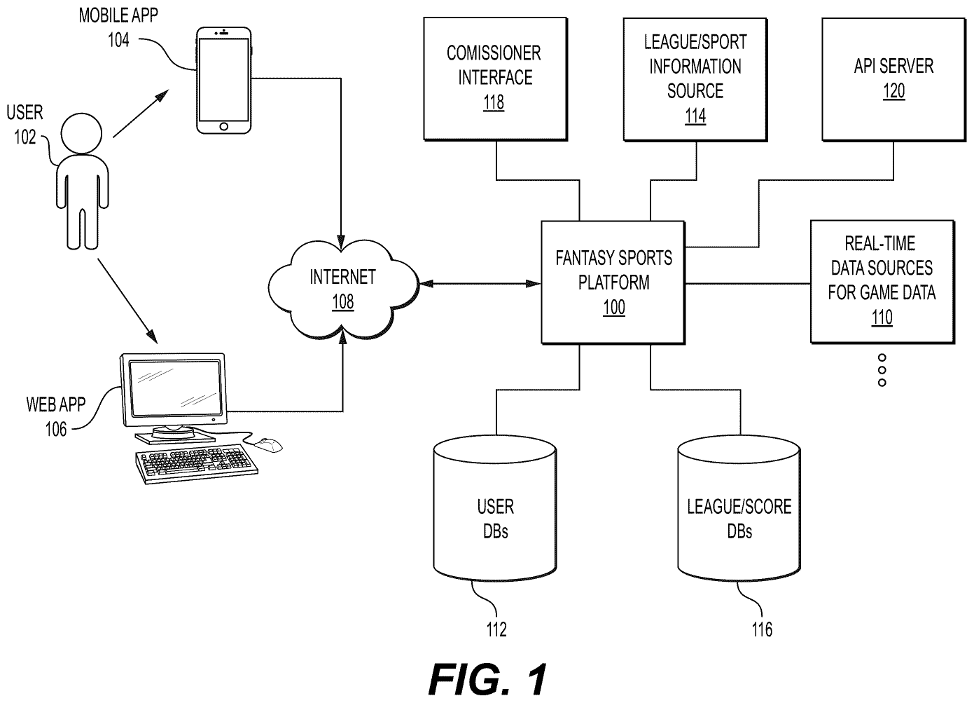

FIG. 1 depicts a system diagram for fantasy sports platform 100. Generally, the examples described herein are related to football fantasy leagues. However, it should be apparent to one of ordinary skill in the art that fantasy sports platform 100 can be used for any fantasy league such as baseball, basketball, cricket, soccer, etc. Users 102 interact with fantasy sports platform 100 through mobile application 104 and/or web application 106 over Internet/WAN 108. As is known in the art, each user 102 is authenticated before accessing fantasy sports platform 100. Any known authentication techniques may be utilized such as username & password, two-factor authentication, biometric authentication, etc. The required authentication for each user 102 may be stored in association with a user profile of each user 102 in user database 112.

In some embodiments, the fantasy sports platform 100 maintains an active bi-directional connection with the mobile platform mobile application 104 or web application 106 after user 102 is authenticated. This enables any updates, such as player injuries and scores, to be sent in real-time to mobile application 104 or web application 106. Users 102 can also communicate real-time changes, such as player swaps, to the fantasy sports platform 100 which maintains the roster, lineups, and points for each user 102. To conserve bandwidth, fantasy sports platform 100 may only maintain real-time communication with users 102 when players or teams associated with their fantasy team are currently playing.

Fantasy sports platform 100 communicates with one or more sports information sources 114 to obtain information such as game schedules, rosters, date changes, player statistics, team statistics, etc. For example, fantasy sports platform 100 may interact with SportsData.io and NFL.com through an application programming interface (API) to request player statistics at predetermined intervals using an API server 120. The predetermined intervals can be longer during midweek when there are no games and shorter when football games are in progress.

Fantasy sports platform 100 also communicates with one or more real-time data sources 110 to present the required real-time information to users 102 on mobile application 104 and/or web application 106 using API server 120 as will be described later. For example, fantasy sports platform 100 may communicate with ESPN.com, cbssports.com, yahoo.com, rotonews.com, or other sports or fantasy sports website, during live games to pull real-time statistics, roster information, injuries, schedule changes, etc. In some embodiments, a real-time feed from Genius Sports, for example, can be used to determine clock stoppages, player injuries, etc. or any other factors associated with a player swap. For example, clock stoppages in football may include, but are not limited to time outs, television time outs, end of a play, change of possession, player carrying the ball goes out of bounds, loose ball is out of bounds, incomplete forward pass, end of a quarter, two-minute warnings, penalty enforcements, extra-point of two-point conversion attempts, punts, offensive fouls, defensive fouls, intentional grounding, illegal forward passes, throwing a pass backwards out of bounds, spiking or throwing the ball after a down ends, intentional fouls, injuries, etc. It should be obvious to one of ordinary skill in the art that the rules of football, or any other sport, may be changed over time and that additional reasons for clock stoppages may be added or removed, even in different versions of the same sport (e.g., NFL, high school football, college football, Canadian football, etc.). Additionally, real-time player or team swaps may be limited to a particular subset of clock stoppages or player substitutions (e.g., injuries or in-game player substitutions). For example, in some embodiments, player swaps may only be allowed at certain clock stoppages or injuries or timeouts while disallowing player swaps at other clock stoppages. The rules for which clock stoppages or substitutions are allowed to be used for player swaps by user 102 can be set per league or by a league commissioner of the fantasy sports league.

If any of the changes are associated with a user 102, they are presented to the user 102 through mobile application 104 or web application 106 through a notification. The user 102 can then make on-the-fly decisions about whether to make a player swap.

User database 112 stores the user profile of the users 102 such as account settings, fantasy leagues participated in, biographical information, and fantasy team information such as player roster, team roster, etc. League database 116 stores the information for each league such as participating users 102, accumulated points, current fantasy league standings, etc.

Fantasy sports league 100 may also comprise commissioner interface 118 that allows a fantasy league manager or commissioner to manage their fantasy leagues. For example, the commissioner interface 118 allows a commissioner to make player swaps for any user 102 participating in the fantasy league.

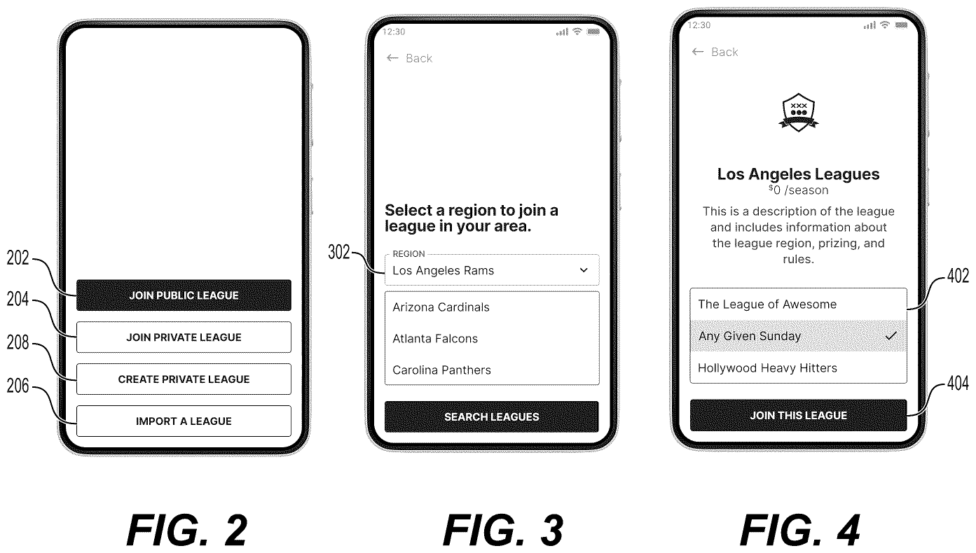

FIGS. 2-4 depict example screens that a user 102 can use to join an open league. The same steps may also be utilized to join any other type of league, such as a private league. As shown in FIG. 2, the user 102 first selects the type of league they wish to join. League types may include public leagues 202, private leagues 204, or imported leagues 206 imported from other platforms. The user 102 is also provided with a create league option 208.

After choosing a fantasy league type, the user is asked to select a region 302 from a predefined listing of regions. The user's location on their mobile device may also be utilized to determine the region. This allows fantasy sports league 100 to determine which leagues can be joined by each user 102. In the example depicted in FIG. 4, the user 102 selected “Los Angeles” as the region. A plurality of league options 402 available to the user 102 are then provided to the user 102. The user 102 may select the “Join” selection 404 to join the selected fantasy league.

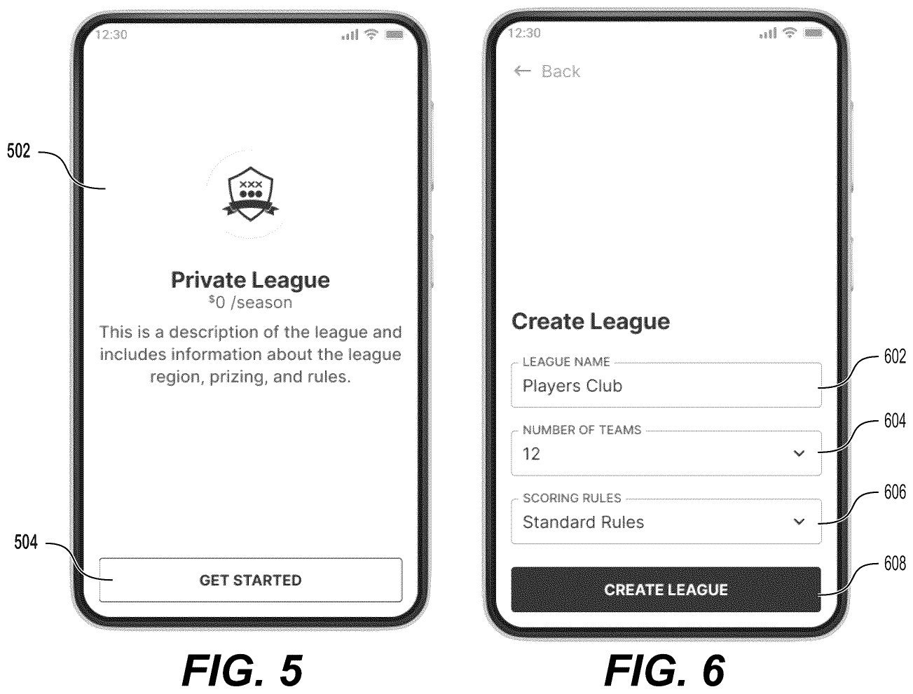

FIGS. 5-10 depict the steps utilized to create a new league if create league option 208 is selected in FIG. 4. The user 102 is first provided with a splash screen 502 regarding the description of the fantasy league. If the user 102 decides to proceed with creating a league, they then select get started option 504.

User 102 can then select a league name 602, number of league teams 604, and scoring rules 606 for the new fantasy league. League name 602 can be any name desired by the user 102 for their new fantasy sports league. The number of league teams 604 can be selected at the time of creation, but teams can later be added or removed if the user 102 (acting as commissioner) changes this setting. Scoring rules 606 determine the scoring rules for the fantasy league. For example, some football fantasy leagues have fairly simple scoring rules reflecting real life scoring (e.g., six points for a touchdown, one point for an extra point kick, two points for a safety, etc.) while other scoring rules are much more complex and award points for defense, points for each reception, defensive player scoring, and bonuses for certain milestones (e.g., 100 yard passing, 200 yards passing, etc.). A user 102 creating a league may also add custom scoring rules in some embodiments. Once selections have been made for options 602-606, the user 102 selects the create league option 608. The new league information is stored in league database 116 and the user profile associated with the user 102 that created the fantasy league is made the commissioner.

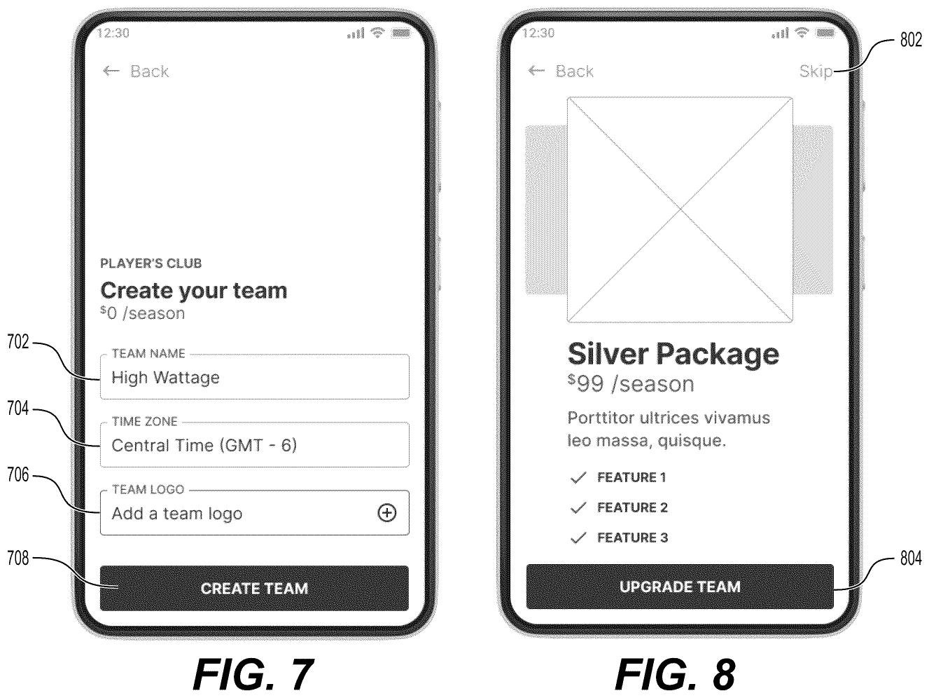

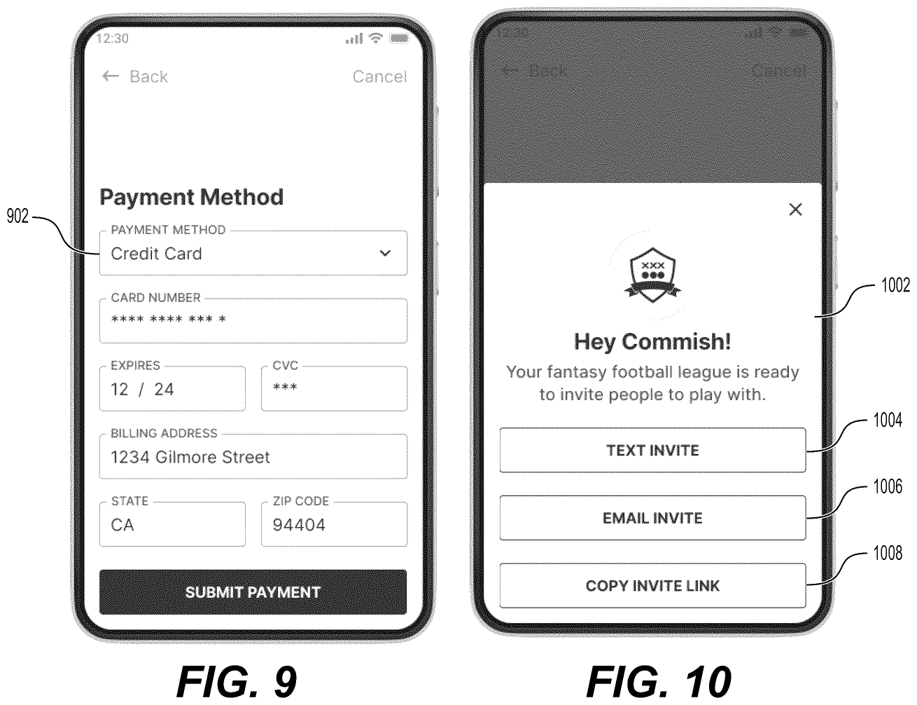

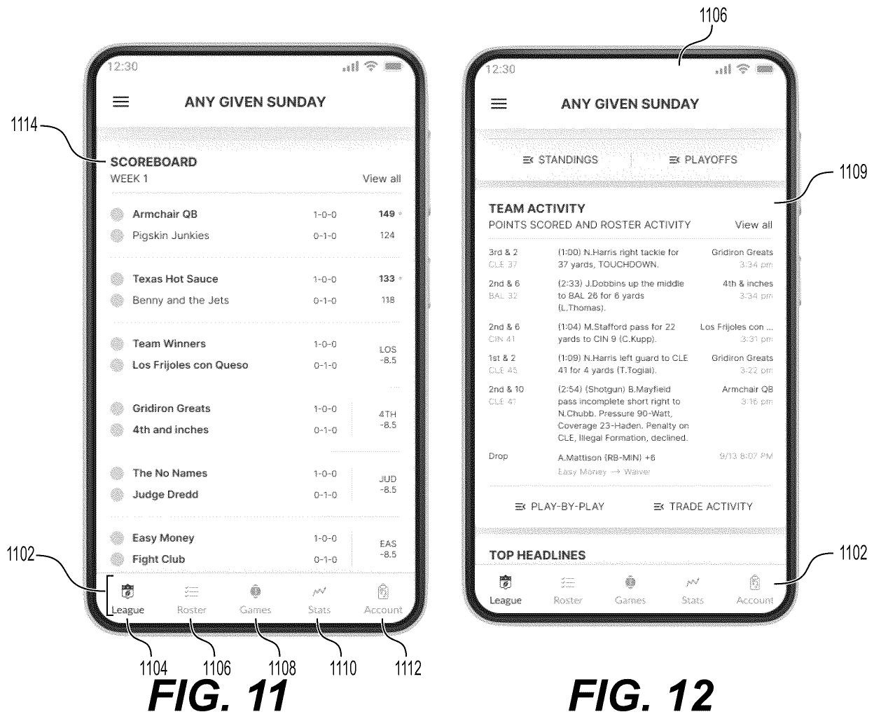

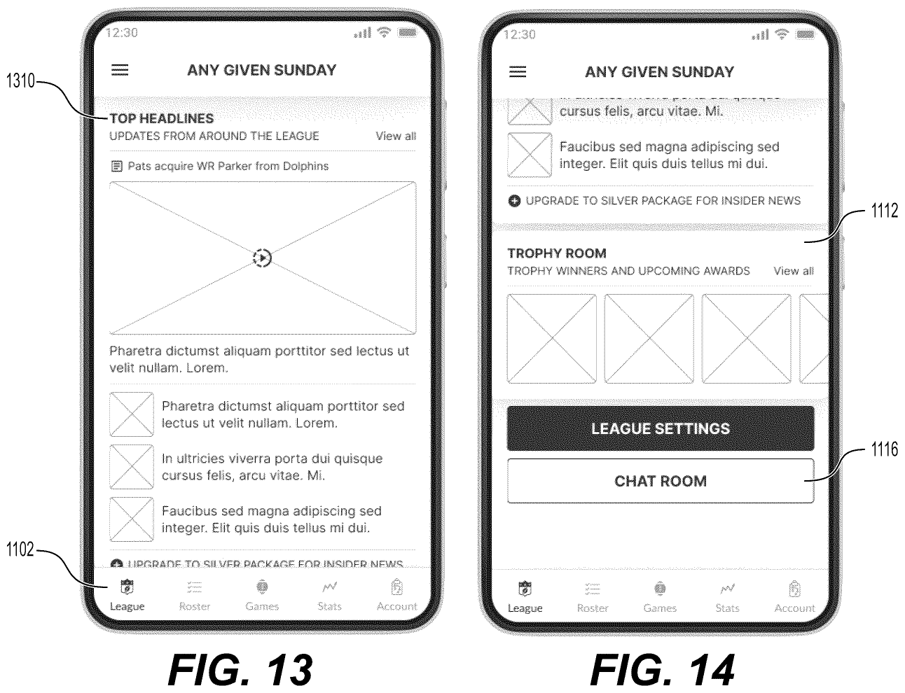

If user 102 is also a participant in the fantasy league, the user 102 is provided with options to create a team as depicted in FIG. 7. The user 102 can select a team name 702, time zone 704, and an image for a team logo 706. The user 102 selects the create team option 708 to create the team. The new team information is then stored in association with the user profile in user database 112. Each user 102 participating in the new league will be provided with the same options when creating their team. In some embodiments, users 102 may be provided with an option to upgrade their new team as depicted in FIG. 8. The upgrade may include additional features not available to basic users 102. If the upgrade is not desired, the user 102 can select the skip option 802. If the user 102 selects the upgrade option 804, the user 102 is directed to select a payment method 902 in FIG. 9. The user 102 may enter their payment information directly or through third-party services, including but not limited to PayPal, Venmo, Apple Pay or Zelle, may be utilized for payment.

After the league has been created, a pop-up screen 1002 may be provided with options to invite other users 102 to the new league. The options may include, but are not limited to, a text invite 1004, an email invite 1006, or a copy invite link 1008. The user can send the invite link 1008 to anyone that wants to join the link. Selection of the invite link will direct them to create a team associated with the league as depicted in FIG. 7.

As depicted in FIG. 11, the mobile application 104 preferably includes a plurality of options arranged on a toolbar 1102. A top or header of the screen preferably indicates the league name because users 102 may belong to several fantasy leagues for one or more sports. The options on toolbar 1102 preferably include league option 1104, roster option 1106, games option 1108, stats option 1110, and account options 1112. User 102 can switch between the different options through a user selection, such as a selection of the relevant icon for the option. League option 1104 allows users 102 to view information associated with their league such as a scoreboard for fantasy league matches, current fantasy team rankings, recent fantasy team activity, headlines, etc. For example, the scoreboard 1114 indicates it is week 1 of the league and the team “Armchair QB” is leading “Pigskin Junkies” 149-124. These scores are all updated in real-time as points are accrued according to the scoring rules set for the fantasy league. As previously discussed, real-time game information can be gathered from real-time data sources 110, points are calculated by fantasy sports platform 100 according to the scoring rules, and scoreboard 1114 is updated as each fantasy team listed accrues points. For example, points from a quarterback may be calculated from statistics such as passing yards, passing touchdowns, rushing yards, rushing touchdowns, fantasy points, fantasy ranking, etc.

League option 1104 may additionally include a team activity section 1109 which provides an ordered listing of points scored and roster/lineup activity/changes as they occur in real-time. For example, if a first user 102 makes a player swap, the team activity section 1109 will display a line item indicating the player swap. League option 1104 may also provide a top headlines section 1310 which includes news articles related to the users' fantasy teams. In some embodiments, fantasy sports platform 100 may maintain a chat room 1116 accessible to users 102 of each fantasy league so that they can chat and exchange messages in real-time within the mobile application 104 and web application 106.

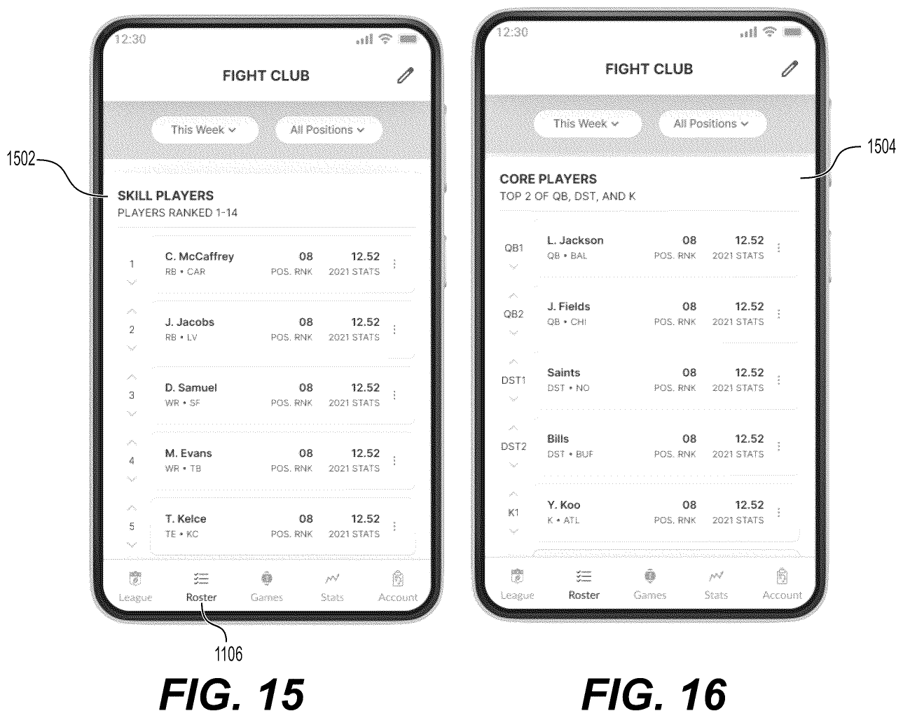

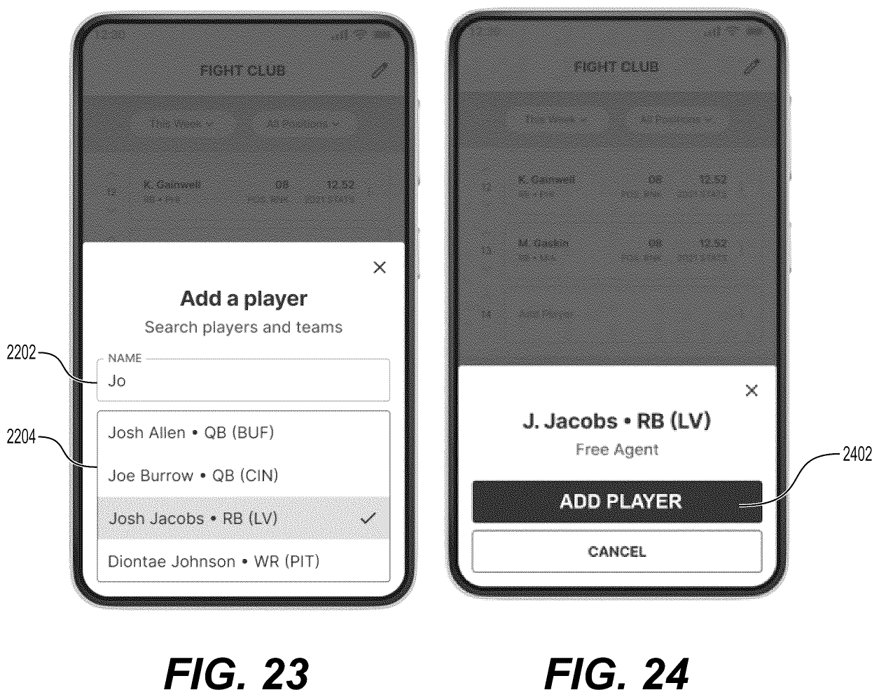

FIGS. 15-25 depict features associated with roster option 1106. Roster option 1106 is utilized to allow users 102 to select their lineup each week and to manage player selections and changes. A first section 1502 may depict skill players as depicted in FIG. 15 while a second section 1504 may depict core players (e.g., top 2 players of each position) as shown in FIG. 16.

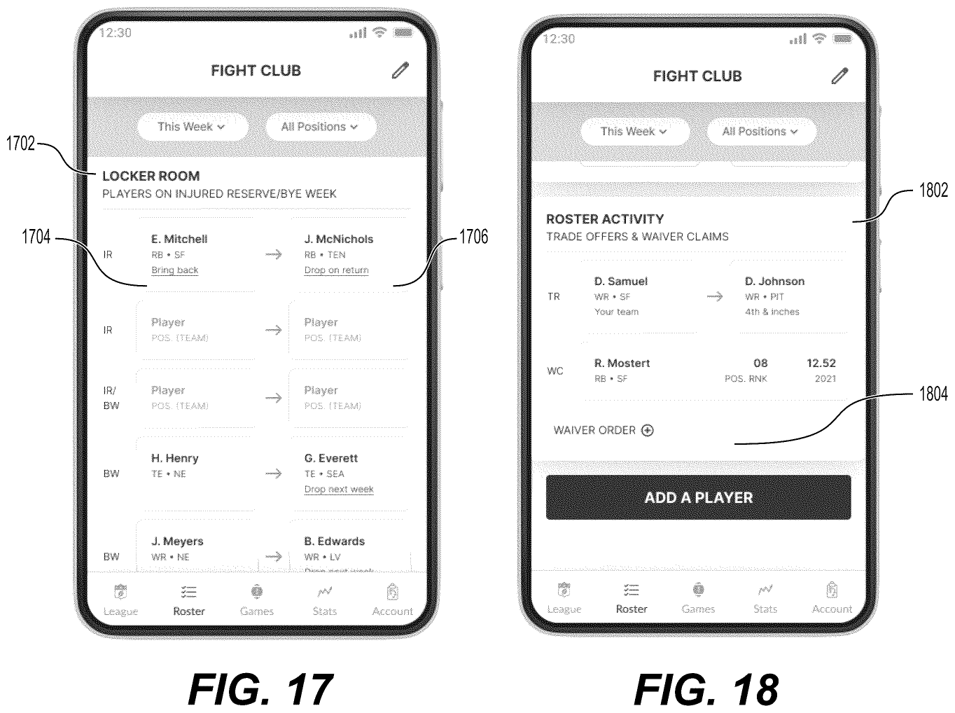

Roster option 1106 further includes locker room section 1702 as depicted in FIG. 17. Users 102 can use this section to swap their players that cannot currently be selected because of injuries or bye-weeks. In case a selected player 1704 is not available, the user 102 may manually swap the unavailable player or can select an automatic swap 1706. If an automatic swap is selected, the fantasy sports platform 100 will automatically swap in an available player to the current lineup from the roster of the user 102.

Roster activity section 1802 allows users 102 to trade players among fantasy teams before the weekly lineup has been set or at any time if the player has not been assigned to a roster or lineup in a particular week. Users 102 may also view their team's waiver order 1804 on this screen. The waiver order determines the user's team's priority versus other teams for adding available players from waivers; teams with the lower waiver order (e.g., waiver order one (1) versus five (5)) will be able to add a player from waivers if two or more teams opt to add the same player. The league rules typically determine the waiver order.

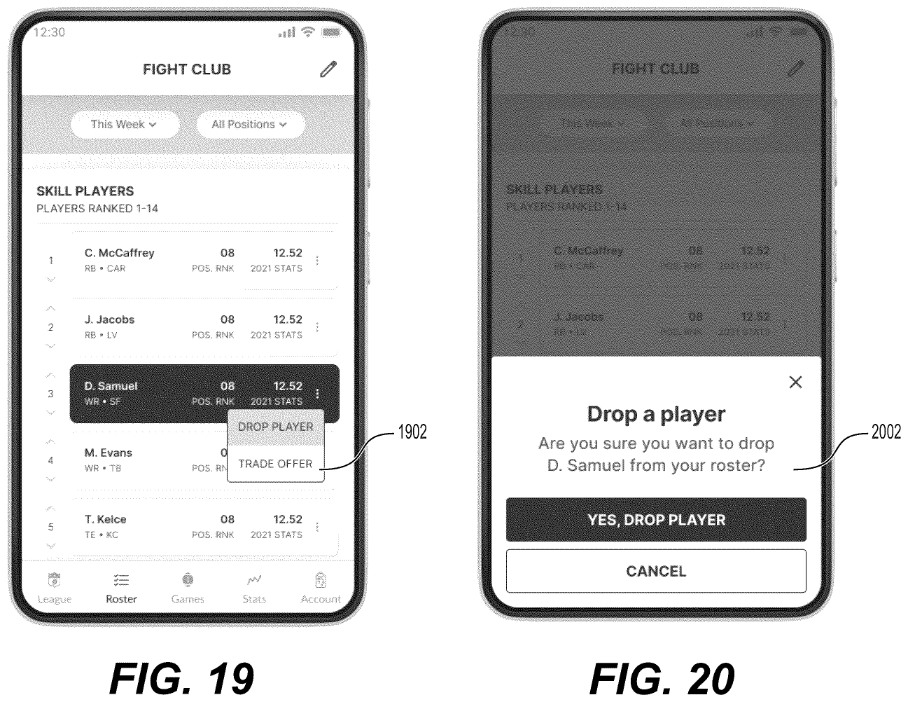

FIG. 19 depicts options available to user 102 if a player is selected from the first section 1502 or second section 1504. Once the player is highlighted as depicted in FIG. 19, one or more options 1902 are presented to the user 102. For example, the user 102 may be provided with an option to drop a player from their roster entirely or offer the player in a trade offer. If the user 102 decides to drop a player, a confirmation screen 2002 is displayed to the user 102 so that the user 102 must confirm the change. Once players are dropped, they may be added to a team by making a waiver claim, as a free agent, or acquired in a trade if another user 102 added them.

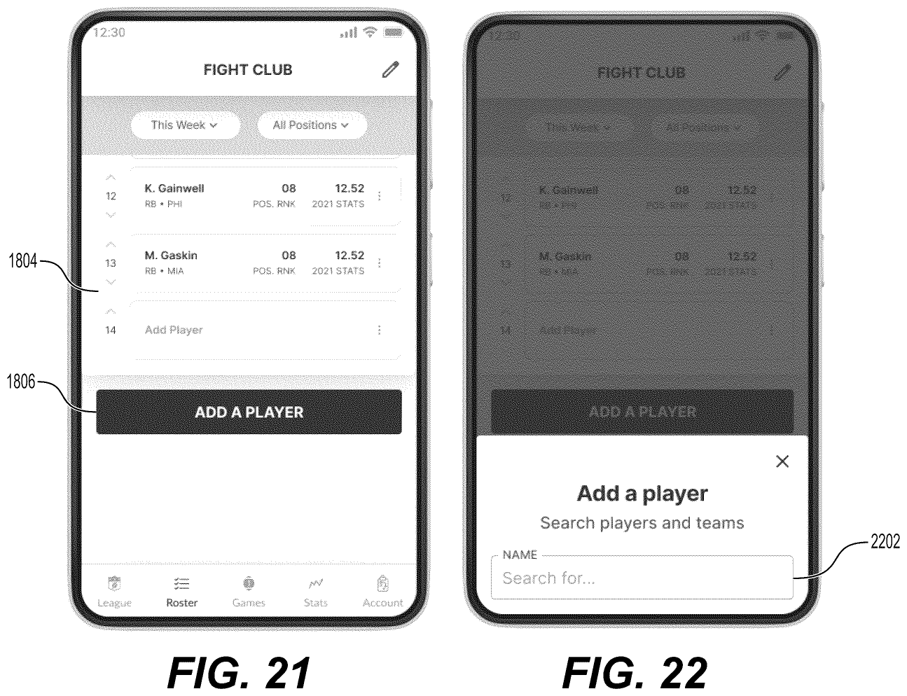

Users 102 may also use roster option 1106 to add players to their roster by selecting an add player option 1806 as depicted in FIG. 21. To add a player, the user 102 is provided with a search screen 2202 as depicted in FIG. 22. The user 102 can type a partial name or an entire name to search for players that can be added. As the user 102 enters characters, results are preferably displayed to the user 102 in the search results section 2204. The user 102 is free to select any player from the search results section 2204. If the player is a free agent or is successfully added through a waiver process, an add confirmation screen 2402 will be displayed as depicted in FIG. 24. If the user 102 decides to draft the player, they will be added to the team roster for the user 102 in first section 1502.

Generally, most fantasy leagues only offer a draft at the beginning of a season for users 102. However, users 102 may also utilize fantasy sports platform 100 to import lineups that they have assembled in other fantasy leagues on fantasy sports platform 100 or even on fantasy sports platforms from competitors. In some embodiments, an entire fantasy sports league from a competitor may be imported into fantasy sports platform 100 wherein the lineups for each user 102 are imported (as well as any other relevant information).

During the draft, users 102 select a lineup in various rounds as is known in the art. In some leagues, users 102 are able to pick up free agents (i.e., non-drafted or dropped players) during the season to add to their lineup. However, fantasy leagues often run for a set number of weeks and then may have playoffs to determine a winner (e.g., during the last four weeks of the regular NFL schedule). For example, in a 12-team league, only four teams may advance to the playoffs. In some embodiments, the players from the remaining eight teams may be made available for a second chance draft that is conducted before the playoffs begin. In the second chance draft, the players from the remaining eight teams are temporarily added to the free agents list and the remaining four teams in the playoffs participate in the second chance draft with the added players. Any players drafted during the second chance draft can be played by the users 102 in the playoffs. Preferably, the players drafted during the second chance draft are not allowed to be holdovers for the playoff teams (i.e., cannot be chosen to be automatically retained for the next fantasy season unlike players drafted before the start of the fantasy season).

In some embodiments, a second chance draft can take place at any point during a season between two or more players within the same fantasy league or other fantasy leagues. For example, prior to a matchup between player A and player B in different leagues, they could conduct a full or limited second chance draft prior to their matchup. The resulting players that are drafted can be temporarily (e.g., just for the single matchup) or more permanently added to each user's 102 lineup.

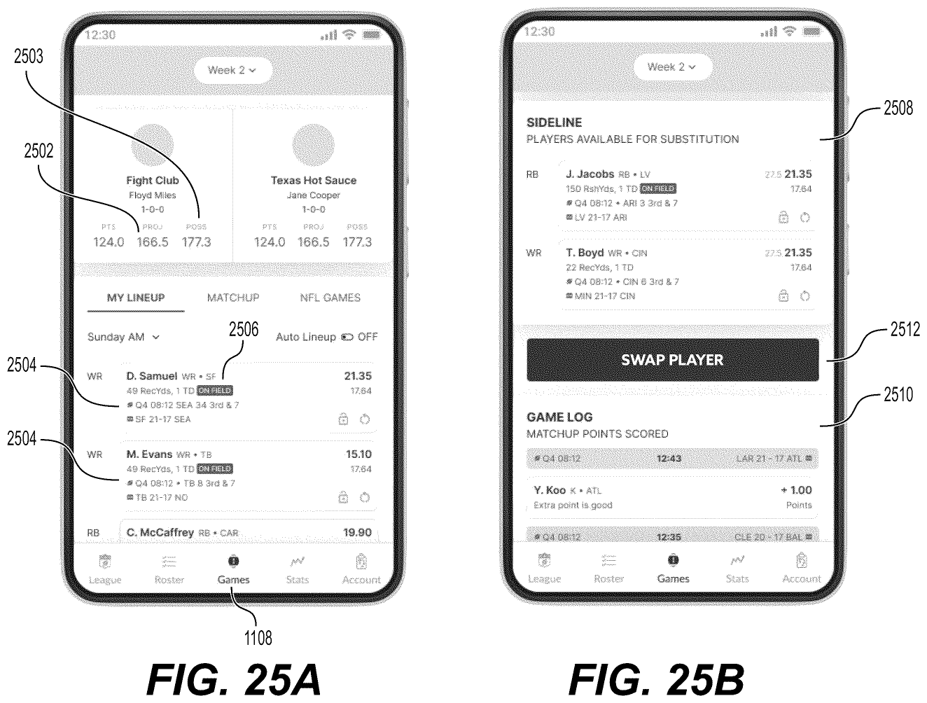

Games option 1108 is used to view the real-time score for the user 102 in their weekly matchup. For example, FIG. 25 depicts that the fantasy team “Fight Club” belonging to “Floyd Miles” is playing the fantasy team “Texas Hot Sauce” belonging to “Jane Cooper” with a current score of 124-124. In some embodiments, fantasy sports platform 100 may calculate projected total points 2502 and possible total points 2503 for each player based on historical data and current trends for each of the user's 102 current lineup or roster. Each player on the current lineup of the user 102 is depicted in a separate player status field 2504. Here, the user 102 can see the current points from each player, their in-game statistics, current score in the live game, etc. Player status field 2504 also includes a status indicator 2506 to indicate a current, real-time status of the player. For example, the status indicator 2506 may indicate that the player is on field, off field, injured, unavailable, etc.

In some embodiments, users 102 may choose to participate in additional weekly matches against other users 102 that are not part of the official schedule. The results of these matches would not count towards standings of the fantasy league but could be used for different users 102 to wager against each other as permitted by local laws, rules, or regulations. For example, user A could challenge user B to a matchup in week 4 of the fantasy league for a set amount of money or another prize (e.g., future draft pick, player, etc.).

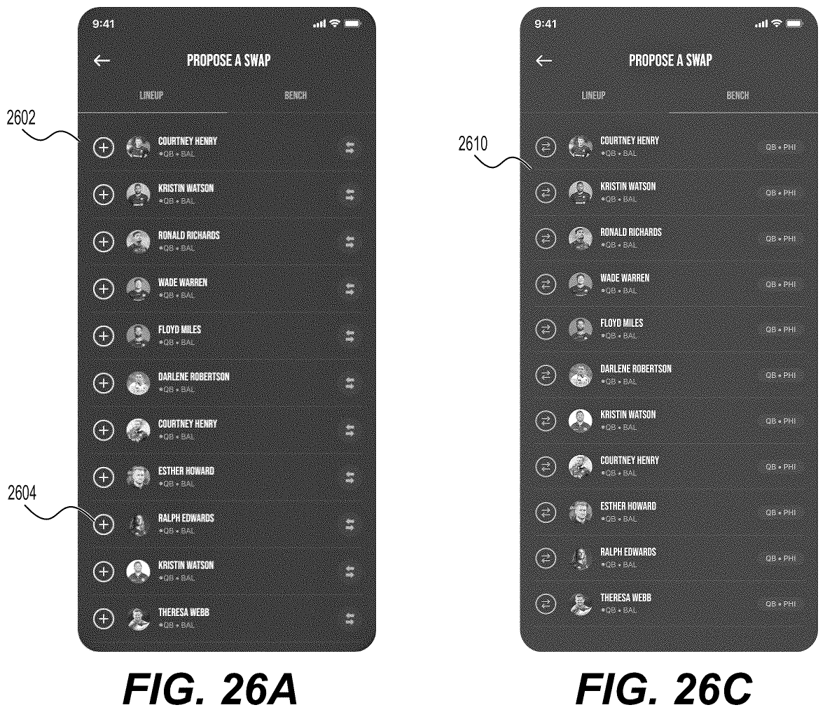

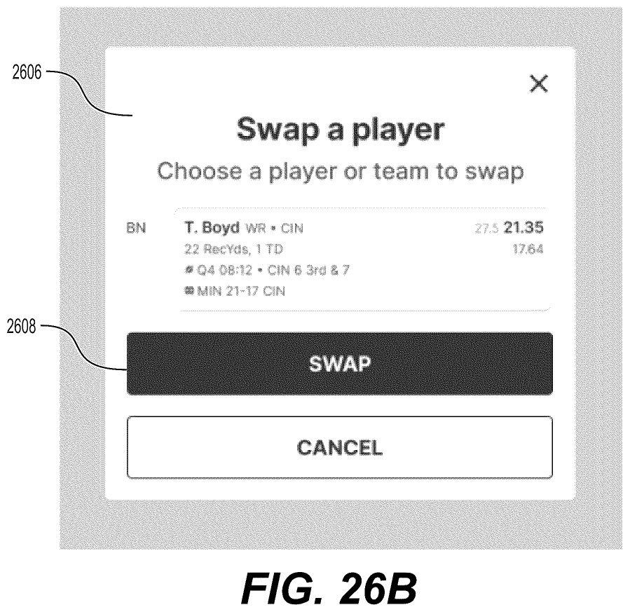

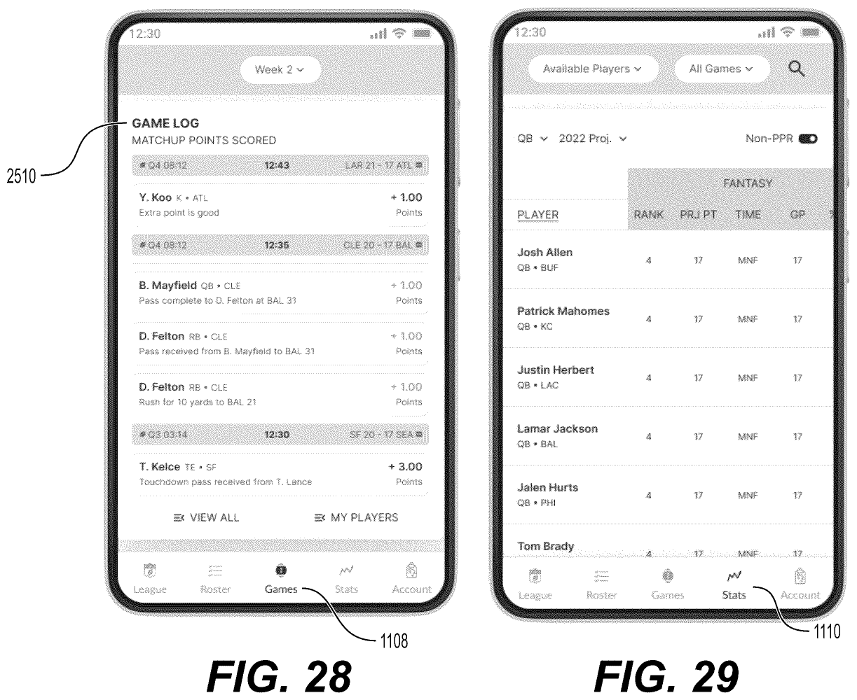

Sideline section 2508 lists all players on the user's current roster for the game that are available for swapping as depicted in FIG. 26. Game log section 2510 provides the user 102 with a breakdown of how each of their points was accrued as depicted in FIGS. 28 and 29.

If a player is selected from sideline section 2508, the user 102 is provided with swap player screen 2606. In the depicted example, the player “T. Boyd” is selected, their current statistics are displayed so the user 102 can make an informed decision. For example, if the player's game is currently in the fourth quarter and there is little time left, the user 102 may decide not to make the swap because it is unlikely that the player would score any additional points.

When user selects swap option 2512, they are presented with a listing of current players in their active lineup that can be removed (FIG. 26A) and bench players available to be swapped (FIG. 26C). As used herein, a lineup generally refers to players that user 102 has selected for competition in a match from their roster and sideline/bench refers to players that were not selected for competition in the match. The lineup must generally be selected each week by user 102. Preferably, players that are available to be swapped are highlighted in some manner such as using the same font color, bolding the font, providing a specific icon (e.g., + or −), greying out certain players so only swappable players can be selected, etc. As previously discussed, the players available for a player swap are determined based on league rules. If a player has already completed their game, they would not be available for a player swap. The icons for each player are updated in real-time in mobile application 104 based on the status of each player in their game (e.g., whether the game has concluded, player is injured, ball is currently in play, etc.).

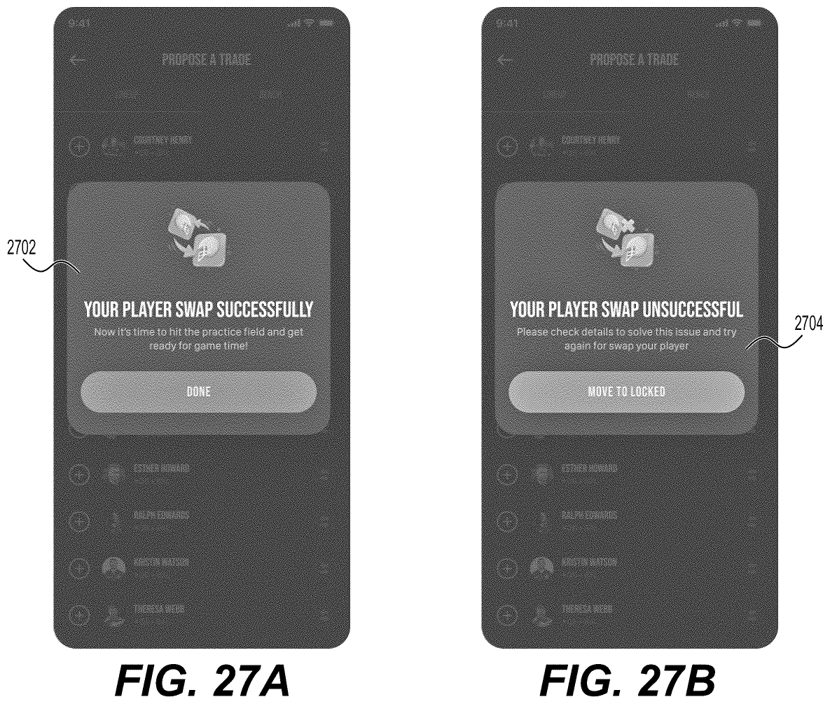

Generally, a user 102 first selects a player to be swapped from their lineup 2602 as depicted in FIG. 26A. An icon 2604 may be provided next to each player used to start a swap. After selecting the icon 2604, the user 102 is provided a notification 2606 with the selected players statistics relevant to the swap (e.g., receiving yards, game time left, etc.) as depicted in FIG. 26B. The user can select the swap option 2608 to be provided a filtered listing of players available for swapping on the bench menu 2610 as depicted in FIG. 26C. The players can be filtered by current game status (e.g., not playing, bye-week, etc.), injury status, current game stoppages, etc.) The user 102 only has to select an icon 2604 next to the player to be swapped. The fantasy sports platform 100 then makes a final determination if the swap can be completed. If the swap can be completed, the user 102 is provided a popup notification 2702 indicating that the swap is successful as depicted in FIG. 27A. If the swap cannot be completed, the user 102 is provided an error message 2704 as depicted in FIG. 27B.

For example, players that have already completed their game would not be listed. If the user 102 decides to proceed with the swap, several timestamps may be recorded in combination with the swap selection. For example, a first timestamp of the user's selection in the mobile application 104 may be recorded and a second timestamp of reception of the player's selection at fantasy sports platform 100 may be recorded. The difference between these timestamps can be used to determine a transmission delay of the swap. If the transmission delay is greater than a predetermined threshold, the user 102 may be notified that their swap was not processed or was processed at the second timestamp. In some embodiments, the user 102 may be able to reject/cancel the swap due to the long transmission time.

In some embodiments, only points that are accrued by the added player after the timestamp (e.g., first timestamp or second timestamp) are counted for the user 102 in their weekly matchup. Any points acquired by the swapped-out player after the timestamp are not counted for the user 102 because the player is no longer in the active line-up. In other embodiments, the points acquired by players may be counted as long as they are in a user's 102 active lineup. For example, if a user 102 selected a first running back that had 3 touch downs in a first game, the user 102 could swap the first running back for a second running back in a later game and also accumulate the points associated with the second running back in the second game (also called “stacking points”). Fantasy sports platform 100 utilizes real-time data sources 110 to maintain the current status of all players and their statistics for the lineup selected by user 102 for the matchup.

In some embodiments, the number of swaps per user 102 may be limited to a predetermined number or unlimited. A fee could also be imposed by fantasy sports platform 100 per player swap or to obtain unlimited swaps. If the number of swaps allowed per player is unlimited, the same user could repeatedly swap player A for player B (and vice versa) as long as the swap is allowed (e.g., there is a clock stoppage allowing the swap). In some embodiments, the user 102 is only awarded points scored by the player for the period of the game that they are in the player's active lineup.

In embodiments, user 102 (as owner and/or commissioner) may set up rules that would automatically swap-out players in their active lineup if one or more certain pre-set conditions are met. For example, a user 102 may set up a rule that causes one of their players to be automatically swapped if the player is removed from a game (e.g., due to injury or ejection). The rule would include a player (or rules for selecting a player) in their sideline section 2508 that would be swapped in for the swapped-out player.

In embodiments, user 102 (as owner and/or commissioner) may set up rules that would provide a team with scoring of the swapped player other than just based on their actual scoring after the timestamp of the swap. For example, a team may be allocated points based on, e.g., a bot-net limited scoring based on the average of their scoring and the swapped-out player's scoring, a median or average score based on an algorithm taking into account the quarter-by-quarter scoring, etc. For example, if a player is swapped in at the ten-minute mark of the 3^{rd} quarter for the swapped player, the fantasy sports platform 100 may generate a combined scoring based on the swapped-in player's statistics from the ten-minute mark of the 3^{rd} quarter of their game. The fantasy sports platform 100 is flexible enough to allow for a variety of scoring mechanisms when swapping players.

Stats option 1110 allows the user 102 to see or search for any type of statistics associated with the sport of the fantasy league as depicted in FIG. 29. For example, users 102 can compare players, see individual player statistics, individual team results, etc. Fantasy sports platform 100 obtains this data primarily from sports information sources 114. Generally, each sport has a plurality of different sources from which statistics can be imported.

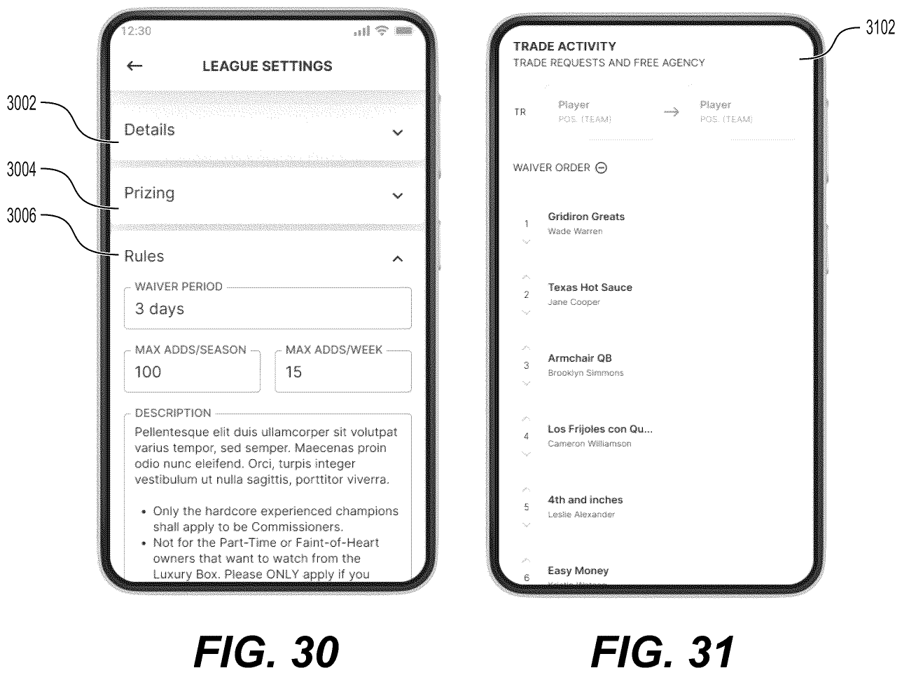

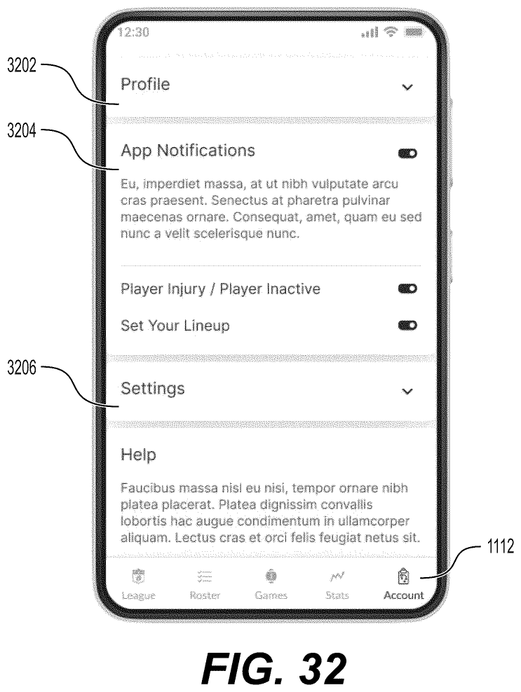

Referring back to FIG. 1, commissioner interface 118 provides the user 102 (acting as commissioner) with the ability to change league settings which is not available to users 102 just having teams (i.e., owners). As depicted in FIG. 30, the user 102 can view details 3002, prize rules 3004, and trade and waiver rules 3006. For example, the user 102 can set a waiver period, limit the number of adds per week or season for each user. In some embodiments, the user 102 is also provided with a trade and waiver activity ledger 3102 as depicted in FIG. 31. Here, the user 102 (as commissioner) can trade players for any user 102, set a waiver order, etc. The commissioner user 102 may also set and change rules, including scoring rules and rules placing limitations on the ability of owner users 102 to swap players out of the active lineup (e.g., prohibiting swaps for ejected players or in other circumstances).

Account options 1112 allows the user 102 to adjust details associated with their user profile 3202, notifications 3204, and setting 3206. Any changes that the user 102 makes to their user profile or settings are updated in user database 112.

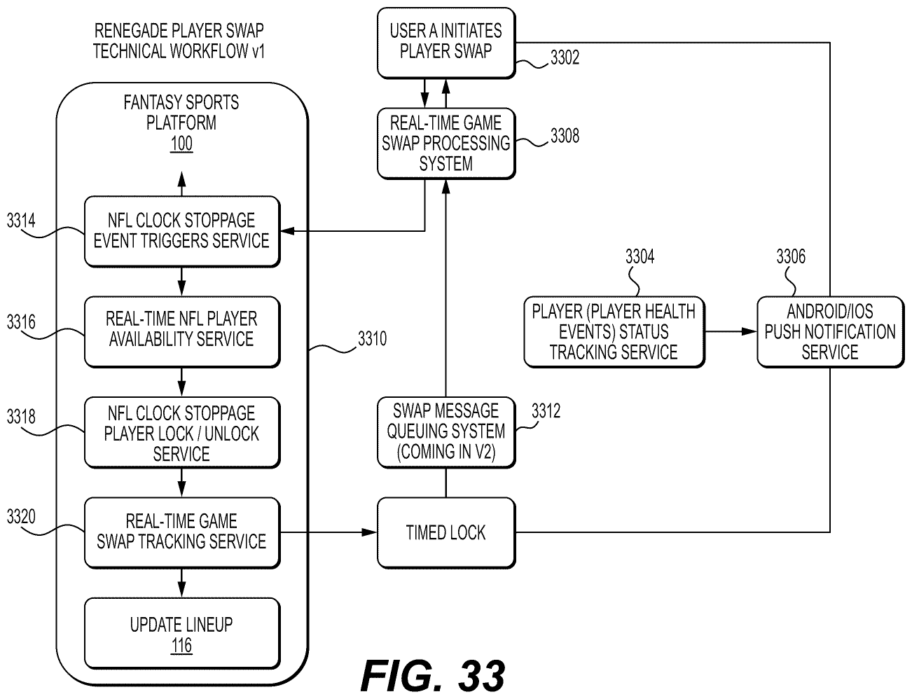

FIG. 33 depicts a flowchart showing the steps utilized to determine if a swap is approved (FIG. 27A) or denied (FIG. 27B). First, a user 102 initiates a player swap using mobile application 104 in step 3302. This may be accomplished, for example, by selecting swap option 2608 as depicted in FIG. 26B. As previously explained, fantasy sports platform 100 constantly monitors real-time data sources 110 and sport information sources 114 in step 3304 and provides any relevant information to each user 102 which is pushed to the mobile applications 104 in step 3306. For example, user 102 may be provided with a real-time notification if a player in their lineup has been injured. In some embodiments, the user 102 may automatically be provided with a pop-up notification for the injured user as depicted in FIG. 26B so that a swap can be made quickly by the user 102.

After receiving a request for a real-time swap in step 3308, fantasy sports platform 100 determines if the swap can be made between player A and player B. As used herein, player A is the player to be swapped and player B is the replacement player. Swaps for first players that have completed their weekly games are automatically excluded from being candidates for swapping in most embodiments to avoid swapping in players based on hindsight analysis. If the second player's game occurs after the conclusion of the first player's game, the swap is automatically approved at the next clock stoppage that occurs in the first player's current game and the timestamp in the game is recorded (e.g., 14 minutes remaining in the 2^{nd} quarter) as well as the time of receipt of the swap request from user 102. In some embodiments, points accrued by the second player in the future game are only counted for user 102 if they occur after the same timestamp (e.g., game time) in the first player's game. In other embodiments, the points accrued by user 102 may be a combination of the total points from player A and player B regardless of the time the swap was made by user 102.

The approval or denial of a swap may incorporate a number of decisions and factors. For example, for each swap decision, the game clock stoppages or player substitutions related to the swap are noted by clock stoppage microservice 3314, real-time player availability of the TBS and SP players are determined by real-time player availability microservice 3316, player lock/unlock microservice 3318 to grey out unavailable players as depicted in FIGS. 26A & 26C, and swap tracking microservice 3320 to determine if all swap criteria are met.

Multiple swaps may be queued by a user 102 in step 3302. Any swaps that can no longer be performed are automatically dropped from the queue (e.g., player injury for a second player). After the swap has been approved or rejected by fantasy sports platform 100 in 3310, a swap decision is provided to the user 102 in step 3312. Examples of swap decisions are depicted in FIGS. 27A and 27B, previously discussed. For all approved swaps, the swap information is noted in league/score database 116 so points are calculated correctly for each user 102.

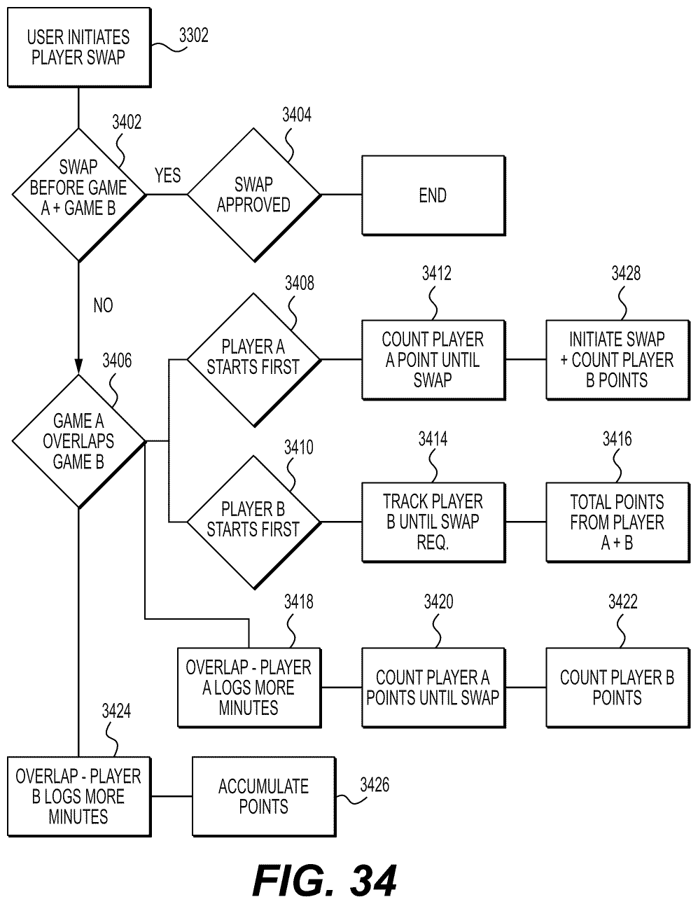

FIG. 34 depicts a flowchart showing the steps utilized to determine if a player swap is approved for a user 102 in different scenarios. The same flowchart is utilized by swap tracking microservice 3318 to determine the approval or denial of every player swap after receiving a user-initiated swap in step 3302. For simplicity, it is assumed that player A is participating in game A and player B is participating in game B. First, swap tracking microservice 3318 determines if the timestamp of the swap is received before the beginning of both game A and game B in step 3402. If the timestamp is before the start of both game A and game B, the swap is approved in step 3404. The points for player B are then counted for the user 102 in step 3428. This type of player swap is referred to generally as a pre-game swap since it occurs before the start of game A and game B. In this scenario, player B would be placed on the active lineup of user 102 in place of player A and the user 102 would only accumulate points associated with player B for the weekly match (e.g., between two fantasy users 102 in a fantasy sports league).

Next, swap tracking microservice 3318 determines if the timestamp of the swap overlaps with game A or game B in step 3406. Next, it is determined if player A starts first in step 3408 or if player B starts first in step 3410. After step 3408, the points accumulated by player A are tracked in game A until the swap request from user 102 is received. For example, player A may have played for five minutes in game A and scored 10 points before the swap request is received. If the swap request is received at the five-minute mark in game A and player B has not yet played, the player B is added to the active lineup in place of player A and user 102 receives points from player B starting from the five-minute mark in game B (or the nearest clock stoppage or player substitution) until the end of game B or until another swap is received for player B (e.g., back to player A or to another player).

After step 3410, the points from player B are tracked for the user 102 until the swap request is received in step 3414. The timestamp of the swap in game B is logged and player A is added to the active lineup of user 102. The user 102 then receives the points from player A in game A from the same point in the game the swap was initiated in game B in step 3416. For example, assume player B plays for 5 minutes in game B and has accumulated 10 points for user 102 when the swap request is received. Player A will then be added to the lineup of user 102 and the user receives the 10 points from player B and all of player A's points accumulated from the five-minute mark of game A onward.

In some situations, game A and game B may start at the same time or in close proximity so that both player A and player B have accumulated playing time. If player A has logged more playing time than player B as determined in step 3418, the user 102 receives points from player A until the swap request is received in step 3420. Player B is then added to the lineup of user 102 in place of player A and the user 102 receives all of player B's points from the same time point in game B onwards in step 3422.

If player A has logged less minutes than player B as determined in step 3424 and the user 102 swaps player B for player A, the user 102 receives the points from player B for time played until the swap was received+player B's points until the time the swap was received in game B+player A's points from the swap time forward For example, assume player B plays for two minutes in game B and scores 10 points and player A plays for five minutes in game A and scores 10 points. The user 102 then swaps player B for player A. The user 102 would receive the 10 points form player B+player B's points until the five-minute mark (i.e., when the swap was received)+player A's points from the five-minute mark going forward.

### Corrections to Real-Time Data Sources 110

In some embodiments, the data received from real-time data sources 110 may be incorrect, incomplete, or later subject to change. For example, some clock stoppages may not be reported in the live feed or corrections to calls, yardage, etc. may be made later in a game or even after a game ends. When corrections are made to the real-time data sources 110, the points for user 102 may be recalculated in view of the new data. For example, a correction could possibly invalidate a swap or set a different timestamp for the swap which would affect the points awarded to user 102. In some embodiments, the corrections must be issued within a predetermined time frame in order to affect the score of user 102. For example, if a correction is made weeks after a match between fantasy users, the correction may not be used to update the previous points awarded to user 102.

While specific embodiments of the invention have been described above, it will be appreciated that the invention may be practiced other than as described. The embodiment(s) described, and references in the specification to “one embodiment,” “an embodiment,” “an example embodiment,” “some embodiments,” etc., indicate that the embodiment(s) described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is understood that it is within the knowledge of one skilled in the art to affect such feature, structure, or characteristic in connection with other embodiments whether or not explicitly described.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

1. A system for real-time player swaps in a fantasy sports match between a first user and a second user, comprising:
a processor for receiving a real-time game data feed; and
a database for storing a first roster and a first lineup for the first user and a second roster and a second lineup for the second user in the fantasy sports match;
wherein the real-time game data feed comprises clock stoppages or player substitutions for the first roster and the second roster;
wherein the processor is configured to:
determine a current game status of players on the first roster and players on the second roster for the fantasy sports match using the real-time game data feed;
calculate points for the first user and points for the second user based on the real-time game data feed;
receive a player swap request from the first user for a first player on the first lineup;
processing the swap request according to rules of the fantasy sports match; and
updating the points for the first user based on a result of the swap request.

2. The system according to claim 1,
wherein the swap request for the first player is approved at a nearest clock stoppage or nearest player substitution in a game of the first player.

3. The system according to claim 2, wherein the first player from the first lineup is swapped for a second player from the first roster in response to the approved swap request.

4. The system according to claim 3, wherein the second player is added to the first lineup for the fantasy sports match in response to the approved swap request.

5. The system according to claim 4, wherein the first player is removed from the lineup at a game point corresponding to the nearest clock stoppage or the nearest player substitution.

6. The system according to claim 5, wherein the first user receives points from the first player until the game point.

7. The system according to claim 1, wherein the first user is in a first fantasy sports league and the second user is in a second fantasy sports league different than the first fantasy sports league.

8. The system according to claim 7, wherein the first lineup does not overlap with the second lineup.

9. The system according to claim 1, wherein the first user and the second user are in a same fantasy sports league.

10. The system according to claim 9, wherein the fantasy sports match is not a scheduled match in the same fantasy sports league between the first user and the second user.

11. The system according to claim 1, wherein the real-time game data feed is received from a real-time game data source.
